(19) United States
(12) Patent Application Publication
(10) Pub. No.: US 2026/0228692 A1
(43) Pub. Date: Aug. 6, 2026

(54) ARTIFICIAL INTELLIGENCE SYSTEMS FOR AUTOMATED EVALUATION OF ELECTRONIC DOCUMENTS AND FEEDBACK GENERATION

(71) Applicant: SmartEsq, Inc., New York, NY (US)

(72) Inventors: Dina Adel Ismail Shalabi, Cairo (EG); Tun-Yu Chiang, New York, NY (US); Kristen Gandhi, Saddle River, NJ (US); Mohamed Maged Khalil Abdelghafar, Dubai (AE); Sheng-Han Wu, Mystic, CT (US)

(21) Appl. No.: 19/468,810

(22) Filed: Feb. 3, 2026

Related U.S. Application Data
(60) Provisional application No. 63/753,376, filed on Feb. 3, 2025.

(51) Int. Cl. G06Q 10/10

(52) U.S. Cl. CPC G06Q 10/10

(57) ABSTRACT

A method for automated comment generation within an electronic document includes: ingesting a first electronic document; extracting semantic information from text and image of the first electronic document; segmenting the extracted semantic information into content groups including legal clauses and legal disclaimers; determining an adequacy score of the legal disclaimer(s), the adequacy score representing disclaimer coverage across predefined regulatory evaluation criteria; generating, based on using LLM(s), an evaluation comment associated with the legal clause(s) of the first content group; modifying the evaluation comment based on the adequacy score; and generating and outputting a second electronic document derived from the first electronic document, where the second electronic document is a structured computer file including content of the first electronic document and the modified regulatory comment mapped to one or more locations corresponding to the one or more the legal clauses within the first electronic document.

### CROSS-REFERENCE TO RELATED APPLICATION

This application claims priority to U.S. Provisional Application No. 63/753,376 filed on Feb. 3, 2025, the contents of which in its entirety are herein incorporated by reference.

### TECHNICAL FIELD

This description generally relates to systems and methods for using artificial intelligence (AI) systems (e.g., large language models (LLMs)) to extract and analyze specific texts or clauses within electronic documents and generate feedback.

### BACKGROUND

Electronic offering, marketing, and investment advisory documents often contain a combination of substantive statements, disclaimers, and visual elements that must be evaluated in context. Existing automated document review tools generally rely on keyword detection or rule-based checks, lack contextual understanding, and fail to consider how disclaimers, footnotes, or regulatory precedent modify the interpretation of potentially non-compliant statements.

### SUMMARY

An aspect of the present disclosure provides a computer-implemented method for automated comment generation within an electronic document. The method includes: ingesting, by one or more processors, a first electronic document comprising text and an image; extracting, by the one or more processors, semantic information from the text and the image of the first electronic document based on using at least one of a native text extraction, an optical character recognition, or an image extraction; segmenting, by the one or more processors, the extracted semantic information into a plurality of content groups comprising at least a first content group and a second content group, the first content group comprising legal clauses and the second content group comprising legal disclaimers; determining, by the one or more processors, an adequacy score of the one or more legal disclaimers, the adequacy score representing disclaimer coverage across predefined regulatory evaluation criteria; generating, by the one or more processors based on using one or more large language models (LLMs), an evaluation comment associated with the one or more legal clauses of the first content group; modifying, by the one or more processors, the evaluation comment based on the adequacy score; and generating and outputting, by the one or more processors, a second electronic document derived from the first electronic document, where the second electronic document is a structured computer file comprising content of the first electronic document and the modified regulatory comment mapped to one or more locations corresponding to the one or more the legal clauses within the first electronic document.

Another aspect of the present disclosure provides a system for automated comment generation within an electronic document. The system includes at least one processor and a memory subsystem communicatively coupled to the at least one processor. The memory subsystem stores instructions which, when executed by the at least one processor, cause the at least one processor to perform operations including: ingesting a first electronic document comprising text and an image; extracting semantic information from the text and the image of the first electronic document based on using at least one of a native text extraction, an optical character recognition, or an image extraction; segmenting the extracted semantic information into a plurality of content groups comprising at least a first content group and a second content group, the first content group comprising legal clauses and the second content group comprising legal disclaimers; determining a adequacy score of the one or more legal disclaimers, the adequacy score representing disclaimer coverage across predefined regulatory evaluation criteria; generating, based on using one or more large language models (LLMs), an evaluation comment associated with the one or more legal clauses; modifying the evaluation comment based on the disclaimer adequacy score; and generating and outputting a second electronic document derived from the first electronic document, where the second electronic document is a structured computer file comprising content of the first electronic document and the modified regulatory comment mapped to one or more locations corresponding to the one or more the legal clauses within the first electronic document.

### BRIEF DESCRIPTION OF THE DRAWINGS

FIG. 1 illustrates a schematic diagram of an example system for automated evaluation of electronic documents and feedback generation.

FIG. 2 illustrates an example cloud computing environment for automated evaluation of electronic documents and feedback generation.

FIG. 3 illustrates a flowchart of an example process for performing automated evaluation of electronic documents and generating feedback.

FIG. 4 depicts an example computing system, according to implementations of the present disclosure.

Like reference numbers and designations in the various drawings indicate like elements.

### DETAILED DESCRIPTION

In some examples, compliance review processes are manual, time-consuming, inconsistent, and difficult to scale. As described above, existing automated document review tools generally rely on keyword detection or rule-based checks, lack contextual understanding, and fail to consider how disclaimers, footnotes, or regulatory precedent modify the interpretation of potentially non-compliant statements. Additionally, many existing solutions introduce data leakage risks by transmitting sensitive documents to third-party systems.

Accordingly, there exists a need for a secure, automated system that can analyze complex offering documents, marketing documents and/or investment advisory documents holistically, interpret disclaimers and regulatory context, incorporate evolving regulatory precedent, and generate precise, context-aware markup and guidance directly within the original document.

In some aspects, implementations of the present disclosure provide computerized AI systems (e.g., having one or more large language models (LLMs)) that can be configured to extract and analyze specific texts or clause (e.g., legal clause) within an electronic document and generate a result or feedback within the electronic document or to a user. As an example, an AI system can process and break down an electronic document into smaller number of pages, extract and categorize certain text or clause, determine associations between different text elements among the certain text or clause, perform an evaluation, and/or generate and present at least some of the processed content (e.g., comment, score, etc.) within the electronic document or to the user.

In some aspects, implementations of the present disclosure provide computerized AI systems that can be configured to: ingest a first electronic document comprising text and an image; extract semantic information from the text and the image of the first electronic document based on using at least one of a native text extraction, an optical character recognition, or an image extraction; after extracting, assigning respective spatial coordinates of the electronic document to respective information of the extracted semantic information; segmenting the extracted semantic information into a plurality of content groups comprising at least a first content group and a second content group, the first content group comprising legal clauses and the second content group comprising legal disclaimers; determining a disclaimer adequacy score of the one or more legal disclaimers, the disclaimer adequacy score representing disclaimer coverage across predefined regulatory evaluation criteria; generating, based on using the one or more LLMs, an evaluation comment associated with the one or more legal clauses; modifying the evaluation comment based the on disclaimer adequacy score; and generating and outputting a second electronic document derived from the first electronic document, the second electronic document comprising content of the first electronic document and the modified regulatory comment mapped to one or more locations corresponding to the one or more the legal clauses within the first electronic document.

In some implementations, the disclaimer adequacy score is generated using a machine learning model that is trained based on (i) customer precedent cases and (ii) regulatory precedent cases and that is configured to predict disclaimer adequacy.

In some implementations, the computerized AI systems include machine learning model configurations that are adapted to incorporate new regulatory guidance, precedent data, and document characteristics while preserving previously learned regulatory interpretations. For example, one or more machine learning models can be trained or updated using incremental or staged training techniques that maintain performance on previously evaluated regulatory dimensions while improving evaluation accuracy for newly introduced regulatory dimensions, customer-specific precedent, document types, etc. In some implementations, one or more operational parameters associated with the machine learning models, scoring framework, or comment generation logic, such as weighting factors, confidence thresholds, or disclaimer adequacy threshold values, can be dynamically adjusted to improve system performance, reduce false positives, or increase consistency across document evaluations.

In some implementations, all processing occurs within a private cloud environment preventing external data access or model training on document content.

The features described herein can beneficial, for example, in enabling the user to review the document and understand user feedback regarding the document in an efficient manner (e.g., without requiring that the user manually review the entire electronic document, perform evaluation, and/or produce and insert feedback at a certain location within the electronic document). Accordingly, the time and effort by the user is reduced (e.g., compared to the time and effort that would be expended by performing a comprehensive manual review, evaluation, and/or production and insertion of the feedback). Similarly, this can reduce the computational resources (e.g., CPU resources, memory resources, network resources, etc.) consumed by the user's computer system in reviewing the document along with other steps leading to generation and insertion of the feedback, and thus can improve the efficiency of the computer system.

In addition, the features described herein include computer-specific aspects, including computer-specific rules (e.g., customized techniques and rules for configuring LLMs, to provide the features described herein. These aspects enable a computer to perform tasks that otherwise could not be performed absent manual human input, and in a manner that is specific to computer systems.

Further, since all processing can be performed within a secure private cloud enclosure, such computerized AI systems and associated methods prevent data leakage, model retraining on customer data, or unauthorized external access.

Example implementations of computerized AI systems and example operations performed by those systems are described herein.

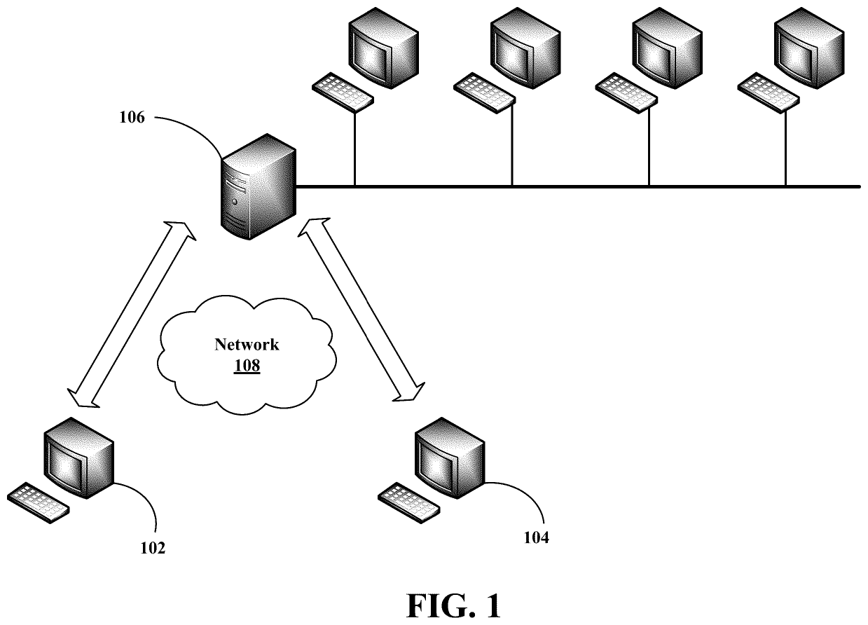

FIG. 1 illustrates a schematic diagram of an example system 100 for automated evaluation of electronic documents and feedback generation. The system 100 can include one or more user computing devices 102, 104, and a set of servers 106 configured to perform automated document-analysis and feedback generation, including document ingestion, text and image extraction, clause and disclaimer segmentation, disclaimer adequacy scoring, regulatory evaluation, comment adjustment, in-document markup generation, and other relevant processing tasks. The computing devices 102 and 104 can communicate with the set of servers 106 over a network 108. The network 108 can include a public network (e.g., internet), a private network, a virtual private cloud (VPC), a local area network, or any combination thereof. In some implementations, one or more of components shown in FIG. 1 can be implemented as physical machines, virtual machines, containers, serverless functions, or other computing entities.

In some implementations, the set of servers 106 can include, or correspond to, a single set of servers or multiple sets of servers. In some implementations, these sets of servers can be co-located or geographically distributed and can communicate via the network 108 or via other networks. In some implementations, the system 100 can include clusters, cloud regions, or other distributed computing resources that are in network communication with each other and with the set of servers 106, e.g., via the network 108.

The one or more user computing devices 102, 104 can be processor-based devices. In some examples, one or more user computing devices 102, 104 can be desktop computers, laptops, mobile devices, tablets, or embedded devices. In some examples, the one or more user computing devices 102 can be capable of providing input of electronic documents, document metadata, compliance related information, or other user inputs described in the present disclosure to the set of servers 106. For instance, users can provide documents, document-related metadata, and regulatory or compliance preferences using graphical interfaces, command-line tools, application programming interfaces (APIs), or the like.

In some implementations, the one or more user computing devices 102, 104 can establish a network connection with the set of servers 106, e.g., via the network 108, and provide natural language input, instructions, datasets (including electronic documents), policy preferences, or other information related to automated regulatory analysis and feedback generation described in the present disclosure. For instance, based on the received inputs, the set of servers 106 can determine or generate (i) structured representations of the document content including clauses, tables, and disclaimers, (ii) one or more disclaimer adequacy scores, and (iii) regulatory evaluation comments, and can further generate an annotated output document that maps the evaluation comments to locations corresponding to the associated content. In some implementations, the set of servers 106 can utilize one or more machine-learning models (which can include one or more LLMs). In some implementations, the set of servers 106 can also establish network connections with internal compute clusters or execution environment(s) configured to perform extraction, retrieval-augmented precedent conditioning, and model inference within a secure private cloud environment.

In some implementations, the set of servers 106 can include or communicate with additional internal components that can be associated with performing extraction, segmentation, retrieval, analysis, secure processing of document content, and other processing tasks related to automated evaluation of electronic documents and feedback generation. These internal components or compute nodes can include virtual machines, physical servers, containers, serverless functions, or other compute substrates that are part of, or managed by, the system 100.

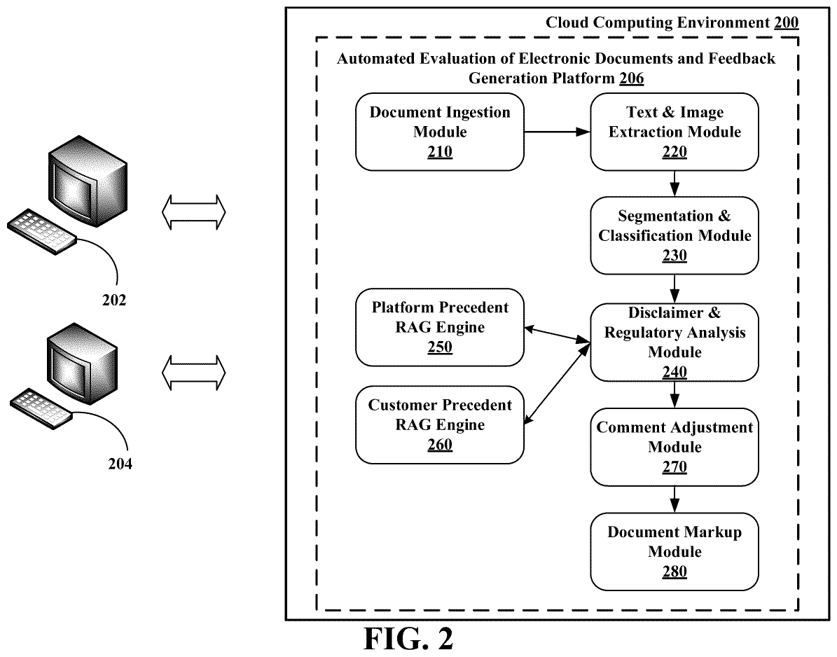

FIG. 2 illustrates an example cloud computing environment 200 for automated evaluation of electronic documents and feedback generation. For instance, FIG. 2 illustrates an example cloud computing environment 200 that provides an integrated platform 206 (automated evaluation of electronic documents and feedback generation platform 206) for receiving electronic documents (e.g., legal documents, regulatory documents, etc.) and related inputs and generating structured document components, disclaimer adequacy scoring, regulatory evaluation comments, and in-document markup. In some examples, the integrated platform 206 can correspond to or include a software. For instance, the software can determine regulatory issues, generate modified comments based on disclaimer adequacy, and produce annotated output documents.

In some examples, the cloud computing environment 200 can be implemented as a distributed cloud platform that includes servers (e.g., the set of servers 106), clusters, or regions connected through one or more internal cloud networks.

The integrated platform 206 can include a document ingestion module 210, a text and image extraction module 220, a segmentation and classification module 230, a disclaimer and regulatory analysis module 240, a platform precedent retrieval-augmented generation (RAG) engine 250, a customer precedent RAG engine 260, a comment adjustment module 270, and a document markup module 280. In some examples, each of these components can be implemented as software services executing on server(s), virtual machines, containers, serverless functions, or other compute substrates within the cloud computing environment 200. In some examples, one or more of these components can be executed using, or deployed on, a set of servers 250 (e.g., which can correspond to the set of servers 106 of FIG. 1.

The document ingestion module 210 can receive one or more electronic documents and/or related inputs from user computing devices 202, 204 (e.g., the one or more user computing devices 102, 104). Such inputs can include PDF files, presentation files, scanned images, associated metadata, natural-language instructions, structured configuration files, and regulatory or compliance preferences and/or related data described in the present disclosure. In some examples, the electronic documents can include text and image(s) and the document ingestion module 210 can provide the electronic document to the text and image extraction module 200.

In some examples, as further described below, based on the received inputs, the integrated platform 206 can extract text and image-derived semantic statements, segment the extracted content into clauses and disclaimers, retrieve regulatory precedent, generate disclaimer adequacy scores, and generate regulatory evaluation comments. In some implementations, the integrated platform 206 can evaluate the document content against applicable regulatory criteria and, after applying disclaimer-based adjustment, generate an annotated output document comprising at least one markup mapped to at least one corresponding location within the original document.

The text and image extraction module 220 can perform native text extraction and optical character recognition (OCR), and can include an image extraction language model configured to extract semantic information from visual elements such as charts, graphics, or images.

In some implementations, when documents including PDFs and/or presentation files are ingested, text can be extracted using a hybrid approach: (1) native text extraction for digitally generated content; and (2) OCR for image-based text. The extracted text can be segmented into pages, clauses, tables, headers, footers, and other structural elements using the text and image extraction module 220, as further described below. Heuristics can be applied to infer relationships between components, including association of images with captions and linkage of footnotes to corresponding text. The images can also be extracted for analysis utilizing an image-based LLM to identify the key point(s), disclaimer(s), and clause(s) (e.g., legal clauses) in the images. Images can then be tied as a clause for further analysis to relate the text to the images.

In some examples, semantic information from the text and the image of the electronic document can be extracted based on using at least one of a native text extraction, an optical character recognition, or an image extraction.

In some implementations, each extracted text or image segment can be assigned spatial coordinates corresponding to its original position within the source electronic document. This enables precise placement of annotations, comments, or visual markers directly within the original electronic document context.

After the extracted content from the text and image extraction module 220 is provided to the segmentation and classification module 230, the segmentation and classification module 230 can decompose the electronic document(s) into structured components (e.g., content groups) including clauses and disclaimers.

The platform precedent RAG engine 250 and the customer precedent RAG engine 260 can retrieve regulatory precedent(s) and related information that are stored in a memory of the cloud computing environment 200 or other server, or that are input by the user computing devices 202, 204 and supply to the disclaimer and regulatory analysis module 240.

In some examples, the platform precedent RAG engine 250 and the customer precedent RAG engine 260 can search online database and retrieve regulatory precedent(s) and other related information.

In some implementations, the platform precedent RAG engine 250 can retrieve regulatory precedent(s) and related information from publicly available (e.g., stored in the memory or available online) or internally available data (e.g., stored in the memory). The retrieved platform precedent can be used to condition regulatory prompts, evaluation logic, and/or disclaimer adequacy scoring, as further described below.

In some implementations, the customer precedent RAG engine 260 can retrieve customer-specific regulatory precedent(s) (including historical documents and decisions) from publicly available or internally available data. The customer precedent data can be used to condition regulatory prompts, evaluation logic, and/or disclaimer adequacy scoring. In some implementations, the platform precedent RAG engine 250 and the customer precedent RAG engine 260 can operate independently or in combination to supply retrieved precedent data to a regulatory prompt and score adjustment layer (i.e., supply the data to the disclaimer and regulatory analysis module 240 and/or the comment adjustment module 270), which can, for example, condition language model inference.

The disclaimer and regulatory analysis module 240 can evaluate identified disclaimer content across multiple regulatory dimensions and generate one or more numerical disclaimer scores (e.g., disclaimer adequacy score). The disclaimer and regulatory analysis module 240 can evaluate individual clauses using a language model conditioned on the retrieved regulatory precedent.

In some examples, prior to substantive regulatory analysis, the disclaimer and regulatory analysis module 240 can identify disclaimer sections located at the beginning, end, or inline within the electronic document. For instance, disclaimers can be extracted using a specialized model or prompt-based classifier. Further, each disclaimer can be evaluated across a plurality of regulatory dimensions (e.g., predefined regulatory evaluation criteria). In some examples, the regulatory dimensions can include performance claims, forward-looking statements, risk disclosure, suitability, and/or general solicitation or advertising restrictions.

For each regulatory dimension, a numerical disclaimer score can be generated representing adequacy and regulatory coverage. The scores can be produced using a trained machine learning model configured to predict disclaimer adequacy.

In some examples, disclaimer score (e.g., disclaimer adequacy score) corresponds to a score representing the adequacy of disclaimer content and its effect on regulatory risk associated with substantive document statements.

For instance, the scoring framework can be algorithmically computable, and to influence downstream system behavior, include confidence scoring, comment severity, and output visibility.

The disclaimer and regulatory analysis module 240 can utilize such scoring framework, as described below, referring to (1) Disclaimer Component Identification, (2) Component Completeness Scoring, (3) Component Quality Scoring, (4) Overall Disclaimer Quality and Coverage Factors, (5) Disclaimer Score Computation, (6) Use of Disclaimer Scores in Regulatory Analysis, and (7) Example Application. By converting disclaimer adequacy into a numerical control variable that algorithmically modifies regulatory outputs, the integrated platform 206 reduces false positives, improves consistency, and enables scalable, automated compliance review that reflects both document context and evolving regulatory guidance.

In some implementations, the disclaimer and regulatory analysis module 240 can generate a synthesized disclaimer assessment comment (e.g., evaluation comment) summarizing overall quality and suggesting improvements.

In some implementations, the disclaimer and regulatory analysis module 240 can utilize LLM with customized prompts such that each clause or content blob within the electronic document can be evaluated against applicable securities, investment adviser, broker dealer or similar regulations. For each clause, the disclaimer and regulatory analysis module 240 can generate at least one of a regulatory interpretation, a suggested comment and/or revision, or a confidence score indicating severity or likelihood of violation. In some examples, the confidence score can be algorithmically adjusted based on the relevant disclaimer score.

In some implementations, the disclaimer and regulatory analysis module 240 can utilize one or more machine learning model (which can include one or more LLMs) that are adapted to incorporate new regulatory guidance, precedent data, and document characteristics while preserving previously learned regulatory interpretations. For example, one or more machine learning models can be trained or updated using incremental or staged training techniques that maintain performance on previously evaluated regulatory dimensions while improving evaluation accuracy for newly introduced regulatory dimensions, customer-specific precedent, document types, etc. In some implementations, one or more operational parameters associated with the machine learning models, scoring framework, or comment generation logic, such as weighting factors, confidence thresholds, or disclaimer adequacy threshold values, can be dynamically adjusted to improve system performance, reduce false positives, or increase consistency across document evaluations. In some implementations, the knowledge pipeline that is associated with platform 206 is used to dynamically adjust the comment generation logic. In some implementations, this is based upon information from outside sources and optionally includes information that is derived from the main user group of the comment adjustment module 270.

The comment adjustment module 270 can modify, suppress, or recharacterize regulatory comments based on the disclaimer scores. In some examples, if a disclaimer sufficiently mitigates a potential violation, the disclaimer and regulatory analysis module 240 advises, modifies or suppresses the corresponding comment.

For example, for illustrative purposes, when a potentially misleading statement is detected (e.g., “Your ROI will be amazing!”), the disclaimer and regulatory analysis module 240, using one or more LLMs, can generate an initial regulatory comment associated with the clause and a corresponding confidence score representing a likelihood or severity of regulatory violation. The comment adjustment module 270 can then receive the numerical disclaimer score as an input and modify the initial regulatory comment and/or confidence score based on the disclaimer score or the degree to which associated disclaimer content qualifies the statement, where the numerical disclaimer score is applied after generation of the initial regulatory comment and confidence score to control modification, suppression, or recharacterization of the regulatory output. If covered (e.g., content is determined to be covered by associated disclaimer content), the comment adjustment module 270 can generate a disclaimer-referenced comment (e.g., context-aware comment) indicating the current disclaimer rating and suggesting improvements rather than issuing a direct violation warning.

In some examples, the platform precedent RAG engine 250 and the customer precedent RAG engine 260 can retrieve data relating to regulatory precedents and other information (e.g., regulatory guidance, enforcement actions, and interpretive materials) that are stored in the memory or available online, as described above, and supply such data to the disclaimer and regulatory analysis module 240 and/or the comment adjustment module 270. For instance, the data can be used to customize LLM prompts, adjust comment confidence scores, and/or modify output visibility based on current regulatory enforcement trends. In some implementations, customer-specific precedent can be optionally incorporated to tailor outputs.

The document markup module 280 can map the modified regulatory comments to locations within the original document to generate an annotated output document. In some examples, the document markup module 280 can generate and output a second electronic document derived from a first electronic document ingested at the document ingestion module 210, where the second electronic document includes content of the first electronic document and the modified regulatory comment mapped to one or more locations corresponding to the one or more the legal clauses within the first electronic document.

In some implementations, the cloud computing environment 200 corresponds to a secure private cloud environment and all components can be executed within such secure private cloud environment, which prevents external data access and prevents document content from being used for external model training.

### Scoring Framework

### (1) Disclaimer Component Identification

The disclaimer and regulatory analysis module 240 can decompose each identified disclaimer into a plurality of disclaimer components corresponding to predefined regulatory dimensions. Non-limiting examples of such dimensions include, but are not limited to: performance claims (general, selective, hypothetical, composite etc.); forward-looking statements; risk disclosures; suitability limitations; and general solicitation or advertising restrictions. The disclaimer and regulatory analysis module 240 can evaluate each disclaimer component independently.

### (2) Component Completeness Scoring

For each regulatory dimension i, the disclaimer and regulatory analysis module 240 can determine whether the disclaimer includes the required informational elements associated with that dimension. A completeness score cicᵢci is assigned to each component, where: ci∈[0,1]cᵢ∈[0,1]ci∈[0,1]; ci=1cᵢ=1ci=1 indicates that all required elements for the dimension are present; and ci<1cᵢ<1ci<1 indicates partial or missing coverage. Completeness can be determined using rule-based checks, classifier models, or prompt-based language model evaluation.

### (3) Component Quality Scoring

For each disclaimer component i, the disclaimer and regulatory analysis module 240 can compute a quality score q representing the substantive adequacy of the component beyond mere presence. The quality scoring can include: semantic similarity comparison against curated reference disclaimers; language model evaluation against exemplar disclosures; and stylistic, specificity, or clarity assessment. Each quality score can satisfy: qi∈[0,1]qᵢ∈[0,1]qi∈[0,1]; and higher values indicate closer alignment with reference-quality disclaimer language.

### (4) Overall Disclaimer Quality and Coverage Factors

In addition to component-level scores, the disclaimer and regulatory analysis module 240 can compute one or more document-level adjustment factors, including: (i) Overall Quality Factor (oq): a normalized value oq∈[0,1]oq∈[0,1]oq∈[0,1] representing aggregate disclaimer clarity and effectiveness across the document; and (ii) Coverage Factor (co): a normalized value co∈[0,1]co ∈[0,1]co∈[0,1]representing the proportion of detected regulatory issues that are addressed or qualified by existing disclaimers. In some examples, coverage can be computed as a ratio of clauses requiring disclaimer qualification to clauses for which adequate disclaimer coverage is detected.

### (5) Disclaimer Score Computation

In some examples, the disclaimer and regulatory analysis module 240 can compute a numerical disclaimer score (DS) using the following formulation:

$$DS = ( {\sum }_{i = 1}^{n} ( {c}_{i} \times {q}_{i} ) ) \times ( op \times co )$$

Here, ci is a completeness score for component i in the range [0,1], qi is a quality score for component i in the range [0,1], oq is an overall quality factor in the range [0,1], and co is a coverage factor in the range [0,1].

In some implementations, alternative weighting schemes, normalization functions, or machine-learned scoring formulations can be used.

### (6) Use of Disclaimer Scores in Regulatory Analysis

The disclaimer and regulatory analysis module 240 can use the computed disclaimer score as an input to clause-level regulatory evaluation. In some examples, the disclaimer score or pieces of it is used to: adjust a confidence score associated with a regulatory comment; suppress generation of a regulatory warning below a threshold value; recharacterize a violation warning as advisory guidance; and/or modify the severity classification or visibility of output comments. The disclaimer score can thereby exert a controlling influence on downstream regulatory analysis and output generation.

### (7) Example Application

For example, a document containing the statement “Your ROI will be amazing!” can initially trigger a high-severity regulatory comment. If the disclaimer and regulatory analysis module 240 and/or comment adjustment module 270 detects an associated disclaimer with high completeness and quality scores for performance claim qualification, the resulting disclaimer score can reduce the confidence or severity of the regulatory comment, or replace it with a recommendation to enhance qualifying language rather than issuing a violation warning. In some implementations, the disclaimer and regulatory analysis module 240 and/or comment adjustment module 270 can suppress regulatory comments when the disclaimer score exceeds a predefined threshold.

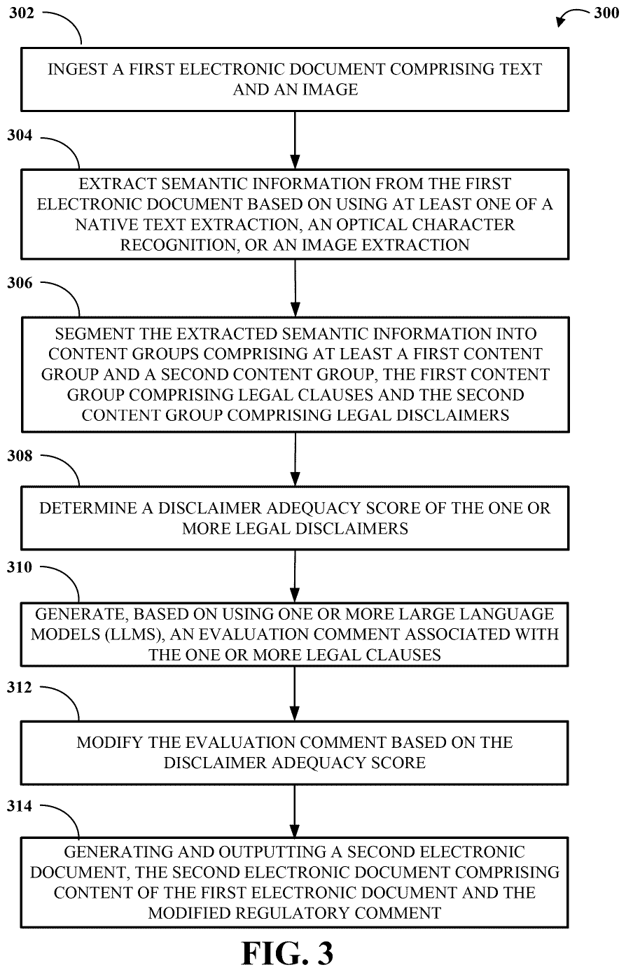

FIG. 3 illustrates a flowchart of an example process 300 for performing automated evaluation of electronic documents and generating feedback. In some implementations, the process 300 (or portions thereof) is performed by the system 100, the cloud environment 200, or integrated platform 206. In some implementations, all or part of the process 300 can be performed by the system 100, the cloud environment 200, or integrated platform 206. The operations shown in the process 300 may not be exhaustive and that other operations can be performed as well before, after, or in between any of the illustrated operations. Further, some of the operations can be performed simultaneously, or in a different order than shown in FIG. 3. Further, the process 300 can be implemented in conjunction with the implementations described with respect to FIGS. 1-2 and 4 of the present disclosure.

At 302, a first electronic document including text and an image is ingested. In some examples, the first electronic document includes at least one of a PDF file or a presentation file. Since the technique regarding the step 302 can be similar to, or the same as, the technique described with respect to the automated evaluation of electronic documents and feedback generation platform 206 of FIG. 2, the description is not repeated here.

At 304, semantic information from the first electronic document is extracted based on using at least one of a native text extraction, an optical character recognition, or an image extraction. Since the technique regarding the step 304 can be similar to, or the same as, the technique described with respect to the automated evaluation of electronic documents and feedback generation platform 206 of FIG. 2, the description is not repeated here.

In some implementations, after extracting the semantic information from the text and the image of the first electronic document, respective spatial coordinates of the first electronic document can be assigning to respective information of the extracted semantic information.

At 306, the extracted semantic information is segmented into content groups including at least a first content group and a second content group, the first content group including legal clauses and the second content group including legal disclaimers. Since the technique regarding the step 306 can be similar to, or the same as, the technique described with respect to the automated evaluation of electronic documents and feedback generation platform 206 of FIG. 2, the description is not repeated here.

At 308, a disclaimer adequacy score of the one or more legal disclaimers is determined. For instance, determining the adequacy score includes: evaluating disclaimer content of the one or more legal disclaimers based on the predefined regulatory evaluation criteria and regulatory precedent cases. Generating the evaluation comment can include: evaluating the one or more legal clauses against securities, investment adviser, broker dealer or other regulatory requirements using the one or more LLMs trained based on the regulatory precedent cases. Evaluating the disclaimer content of the one or more legal disclaimers can be performed prior to evaluating the one or more legal clauses.

In some implementations, the regulatory evaluation criteria can include criteria related to performance claims, forward-looking statements, or risk disclosures.

In some implementations, the adequacy score can be generated using a machine learning model that is trained based on (i) customer precedent cases and (ii) regulatory precedent cases and that is configured to predict disclaimer adequacy.

Additionally, other technique regarding the step 308 can be incorporated based on the technique described with respect to the automated evaluation of electronic documents and feedback generation platform 206 of FIG. 2.

At 310, based on using one or more LLMs, an evaluation comment associated with the one or more legal clauses is generated. For instance, the evaluation comment includes a confidence score that is determined based on the disclaimer adequacy score. In some implementations, retrieving regulatory precedent using a retrieval-augmented generation system, and using the regulatory precedent to evaluate the one or more legal clauses prior to generating the evaluation comment associated with the one or more legal clauses. Additionally, other technique regarding the step 310 can be incorporated based on the technique described with respect to the automated evaluation of electronic documents and feedback generation platform 206 of FIG. 2.

At 312, the evaluation comment is modified based on the disclaimer adequacy score. In some examples, modifying the evaluation comment includes replacing a violation warning with disclaimer-referenced guidance. Additionally, other technique regarding the step 312 can be incorporated based on the technique described with respect to the automated evaluation of electronic documents and feedback generation platform 206 of FIG. 2.

At 314, a second electronic document is generated and output. The second electronic document is a structured computer file including content of the first electronic document and the modified regulatory comment mapped to one or more locations corresponding to the one or more the legal clauses within the first electronic document. In some examples, the second electronic document includes at least one of a word-processing document, a PDF document, or a presentation document, and includes one or more annotations anchored to coordinates or content identifiers corresponding to the one or more legal clauses.

Since the technique regarding the step 314 can be similar to, or the same as, the technique described with respect to the automated evaluation of electronic documents and feedback generation platform 206 of FIG. 2, the description is not repeated here.

In some implementations, all processing of the process 300 occurs within a private cloud environment to thereby prevent external data access or model training on document content.

### Example Computer Systems

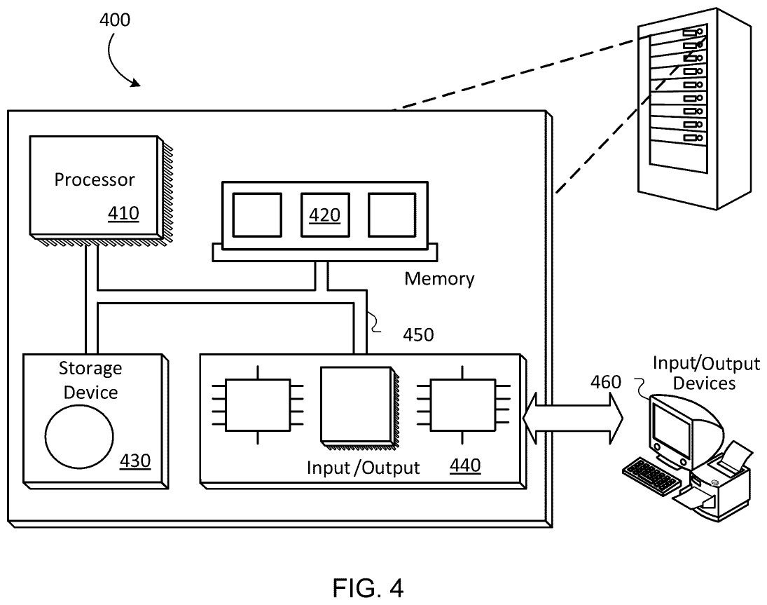

FIG. 4 depicts an example computing system, according to implementations of the present disclosure. The system 400 can be used for any of the operations described with respect to the various implementations discussed herein. The system 400 can include one or more processors 410, a memory 420, one or more storage devices 430, and one or more input/output (I/O) devices 460 controllable through one or more I/O interfaces 440. The various components 410, 420, 430, 440, or 460 can be interconnected through at least one system bus 450, which can enable the transfer of data between the various modules and components of the system 400.

The processor(s) 410 can be configured to process instructions for execution within the system 400. The processor(s) 410 can include single-threaded processor(s), multi-threaded processor(s), or both. The processor(s) 410 can be configured to process instructions stored in the memory 420 or on the storage device(s) 430. The processor(s) 410 can include hardware-based processor(s) each including one or more cores. The processor(s) 410 can include general purpose processor(s), special purpose processor(s), or both.

The memory 420 can store information within the system 400. In some implementations, the memory 420 includes one or more computer-readable media. The memory 420 can include any number of volatile memory units, any number of non-volatile memory units, or both volatile and non-volatile memory units. The memory 420 can include read-only memory, random access memory, or both. In some examples, the memory 420 can be employed as active or physical memory by one or more executing software modules.

The storage device(s) 430 can be configured to provide (e.g., persistent) mass storage for the system 400. In some implementations, the storage device(s) 430 can include one or more computer-readable media. For example, the storage device(s) 430 can include a floppy disk device, a hard disk device, an optical disk device, or a tape device. The storage device(s) 430 can include read-only memory, random access memory, or both. The storage device(s) 430 can include one or more of an internal hard drive, an external hard drive, or a removable drive.

One or both of the memory 420 or the storage device(s) 430 can include one or more computer-readable storage media (CRSM). The CRSM can include one or more of an electronic storage medium, a magnetic storage medium, an optical storage medium, a magneto-optical storage medium, a quantum storage medium, a mechanical computer storage medium, and so forth. The CRSM can provide storage of computer-readable instructions describing data structures, processes, applications, programs, other modules, or other data for the operation of the system 400. In some implementations, the CRSM can include a data store that provides storage of computer-readable instructions or other information in a non-transitory format. The CRSM can be incorporated into the system 400 or can be external with respect to the system 400. The CRSM can include read-only memory, random access memory, or both. One or more CRSM suitable for tangibly embodying computer program instructions and data can include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some examples, the processor(s) 410 and the memory 420 can be supplemented by, or incorporated into, one or more application-specific integrated circuits (ASICs).

The system 400 can include one or more I/O devices 460. The I/O device(s) 460 can include one or more input devices such as a keyboard, a mouse, a pen, a game controller, a touch input device, an audio input device (e.g., a microphone), a gestural input device, a haptic input device, an image or video capture device (e.g., a camera), or other devices. In some examples, the I/O device(s) 460 can also include one or more output devices such as a display, LED(s), an audio output device (e.g., a speaker), a printer, a haptic output device, and so forth. The I/O device(s) 460 can be physically incorporated in one or more computing devices of the system 400, or can be external with respect to one or more computing devices of the system 400.

The system 400 can include one or more I/O interfaces 440 to enable components or modules of the system 400 to control, interface with, or otherwise communicate with the I/O device(s) 460. The I/O interface(s) 440 can enable information to be transferred in or out of the system 400, or between components of the system 400, through serial communication, parallel communication, or other types of communication. For example, the I/O interface(s) 440 can comply with a version of the RS-232 standard for serial ports, or with a version of the IEEE 1284 standard for parallel ports. As another example, the I/O interface(s) 440 can be configured to provide a connection over Universal Serial Bus (USB) or Ethernet. In some examples, the I/O interface(s) 440 can be configured to provide a serial connection that is compliant with a version of the IEEE 1394 standard.

The I/O interface(s) 440 can also include one or more network interfaces that enable communications between computing devices in the system 400, or between the system 400 and other network-connected computing systems. The network interface(s) can include one or more network interface controllers (NICs) or other types of transceiver devices configured to send and receive communications over one or more networks using any network protocol.

Computing devices of the system 400 can communicate with one another, or with other computing devices, using one or more networks. Such networks can include public networks such as the internet, private networks such as an institutional or personal intranet, or any combination of private and public networks. The networks can include any type of wired or wireless network, including but not limited to local area networks (LANs), wide area networks (WANs), wireless WANs (WWANs), wireless LANs (WLANs), mobile communications networks (e.g., 3G, 4G, Edge, etc.), and so forth. In some implementations, the communications between computing devices can be encrypted or otherwise secured. For example, communications can employ one or more public or private cryptographic keys, ciphers, digital certificates, or other credentials supported by a security protocol, such as any version of the Secure Sockets Layer (SSL) or the Transport Layer Security (TLS) protocol.

The system 400 can include any number of computing devices of any type. The computing device(s) can include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a system on a chip (SoC), a system in a package (SiP), and so forth. Although examples herein can describe computing device(s) as physical device(s), implementations are not so limited. In some examples, a computing device can include one or more of a virtual computing environment, a hypervisor, an emulation, or a virtual machine executing on one or more physical computing devices. In some examples, two or more computing devices can include a cluster, cloud, farm, or other grouping of multiple devices that coordinate operations to provide load balancing, failover support, parallel processing capabilities, shared storage resources, shared networking capabilities, or other aspects.

This specification uses the term “configured” in connection with systems and computer program components. For a system of one or more computers to be configured to perform particular operations or actions means that the system has installed on software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively, or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which can also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program can, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which can be organized and accessed differently.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

The term “memory subsystem” can include one or more memories, where each memory can be a computer-readable medium. A memory subsystem can encompass memory hardware units (e.g., a hard drive or a disk) that store data or instructions in software form. Alternatively or in addition, the memory subsystem can include data or instructions that are hard-wired into processing circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features can be described above as acting in certain combinations and even initially be claimed as such, one or more features from a claimed combination can in some cases be excised from the combination, and the claimed combination can be directed to a sub combination or variation of a sub combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

What is claimed is:

1. A computer-implemented method for automated comment generation within an electronic document, the method comprising:
ingesting, by one or more processors, a first electronic document comprising text and an image;
extracting, by the one or more processors, semantic information from the text and the image of the first electronic document based on using at least one of a native text extraction, an optical character recognition, or an image extraction;
segmenting, by the one or more processors, the extracted semantic information into a plurality of content groups comprising at least a first content group and a second content group, the first content group comprising legal clauses and the second content group comprising legal disclaimers;
determining, by the one or more processors, an adequacy score of the one or more legal disclaimers, the adequacy score representing disclaimer coverage across predefined regulatory evaluation criteria;
generating, by the one or more processors based on using one or more large language models (LLMs), an evaluation comment associated with the one or more legal clauses of the first content group;
modifying, by the one or more processors, the evaluation comment based on the adequacy score; and
generating and outputting, by the one or more processors, a second electronic document derived from the first electronic document, wherein the second electronic document is a structured computer file comprising content of the first electronic document and the modified regulatory comment mapped to one or more locations corresponding to the one or more the legal clauses within the first electronic document.

2. The method of claim 1, wherein determining the adequacy score comprises:
evaluating disclaimer content of the one or more legal disclaimers based on the predefined regulatory evaluation criteria and regulatory precedent cases,
wherein generating the evaluation comment comprises:
evaluating the one or more legal clauses against at least one of securities, investment adviser, broker dealer or other regulatory requirements using the one or more LLMs trained based on the regulatory precedent cases, and
wherein evaluating the disclaimer content of the one or more legal disclaimers is performed prior to evaluating the one or more legal clauses.

3. The method of claim 1, comprising:
after extracting the semantic information from the text and the image of the first electronic document, assigning respective spatial coordinates of the first electronic document to respective information of the extracted semantic information.

4. The method of claim 1, wherein the regulatory evaluation criteria comprise criteria related to at least one of performance claims, forward-looking statements, or risk disclosures.

5. The method of claim 1, wherein the adequacy score is generated using a machine learning model that is trained based on (i) customer precedent cases and (ii) regulatory precedent cases, and wherein the machine learning model is configured to predict disclaimer adequacy.

6. The method of claim 1, wherein modifying the evaluation comment comprises replacing a violation warning with disclaimer-referenced guidance.

7. The method of claim 1, wherein the evaluation comment comprises a confidence score that is determined based on the disclaimer adequacy score.

8. The method of claim 1, comprising:
retrieving regulatory precedent using a retrieval-augmented generation system, and
using the regulatory precedent to evaluate the one or more legal clauses prior to generating the evaluation comment associated with the one or more legal clauses.

9. The method of claim 1, wherein the first electronic document comprises at least one of a PDF file or a presentation file.

10. The method of claim 1, wherein all processing occurs within a private cloud environment to thereby prevent external data access or model training on document content.

11. A system for automated comment generation within an electronic document, the system comprising:
at least one processor; and
a memory subsystem communicatively coupled to the at least one processor, the memory subsystem storing instructions which, when executed by the at least one processor, cause the at least one processor to perform operations comprising:
ingesting a first electronic document comprising text and an image;
extracting semantic information from the text and the image of the first electronic document based on using at least one of a native text extraction, an optical character recognition, or an image extraction;
segmenting the extracted semantic information into a plurality of content groups comprising at least a first content group and a second content group, the first content group comprising legal clauses and the second content group comprising legal disclaimers;
determining a adequacy score of the one or more legal disclaimers, the adequacy score representing disclaimer coverage across predefined regulatory evaluation criteria;
generating, based on using one or more large language models (LLMs), an
evaluation comment associated with the one or more legal clauses;
modifying the evaluation comment based on the disclaimer adequacy score; and
generating and outputting a second electronic document derived from the first electronic document, wherein the second electronic document is a structured computer file comprising content of the first electronic document and the modified regulatory comment mapped to one or more locations corresponding to the one or more the legal clauses within the first electronic document.

12. The system of claim 11, wherein determining the adequacy score comprises:
evaluating disclaimer content of the one or more legal disclaimers based on the predefined regulatory evaluation criteria and regulatory precedent cases,
wherein generating the evaluation comment comprises:
evaluating the one or more legal clauses against at least one of securities, investment adviser, broker dealer or other regulatory requirements using the one or more LLMs trained based on the regulatory precedent cases, and
wherein evaluating the disclaimer content of the one or more legal disclaimers is performed prior to evaluating the one or more legal clauses.

13. The system of claim 11, wherein the operations comprise:
after extracting the semantic information from the text and the image of the first electronic document, assigning respective spatial coordinates of the first electronic document to respective information of the extracted semantic information.

14. The system of claim 11, wherein the regulatory evaluation criteria comprise criteria related to at least one of performance claims, forward-looking statements, or risk disclosures.

15. The system of claim 11, wherein the adequacy score is generated using a machine learning model that is trained based on (i) customer precedent cases and (ii) regulatory precedent cases, and wherein the machine learning model is configured to predict disclaimer adequacy.

16. The system of claim 11, wherein modifying the evaluation comment comprises replacing a violation warning with disclaimer-referenced guidance.

17. The system of claim 11, wherein the evaluation comment comprises a confidence score that is determined based on the disclaimer adequacy score.

18. The system of claim 11, wherein the operations comprise:
retrieving regulatory precedent using a retrieval-augmented generation system, and
using the regulatory precedent to evaluate the one or more legal clauses prior to generating the evaluation comment associated with the one or more legal clauses.

19. The system of claim 11, wherein the first electronic document comprises at least one of a PDF file or a presentation file.

20. The system of claim 11, wherein the operations are performed within a private cloud environment to thereby prevent external data access or model training on document content.
